(19) United States
(12) Patent Application Publication
(10) Pub. No.: US 2008/0096992 A1
(43) Pub. Date: Apr. 24, 2008

(54) Flame Retardant Extruded Polystyrene Foam Compositions

(75) Inventors: Kimberly A. Maxwell, Baton Rouge, LA (US); William J. Layman Jr., Baton Rouge, LA (US)

Correspondence Address: EDGAR SPIELMAN;ALBEMARLE CORPORATION, 451 FLORIDA BLVD., BATON ROUGE, LA, 70801, US

(73) Assignee: ALBEMARLE CORPORATION, BATON ROUGE, LA (US)

(21) Appl. No.: 11/722,463

(22) PCT Filed: Dec. 22, 2004
(86) PCT No.: PCT/US04/43352

§ 371 Date: Jun. 21, 2007

(51) Int. Cl. C08J 9/04; C08J 9/12; C08L 25/06

(52) U.S. Cl. 521/79; 521/143

(57) ABSTRACT

Extrudable polystyrene foam compositions having flame retardant properties, flame retardant extruded polystyrene foams, methods of making such foams, and products comprising such compositions and foams are provided. A flame-retarded extruded polystyrene foam contains a flame retardant compound having the structure: Formula (I)

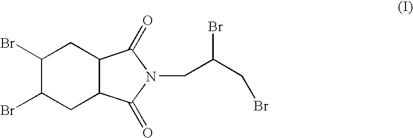

### FIELD OF THE INVENTION

The present invention relates to flame retardant compositions and extruded polystyrene foams formed therefrom.

### BACKGROUND OF THE INVENTION

Styrenic polymer compositions and foams, such as extruded polystyrene foam, are used widely in the manufacture of extruded articles, paints, films coatings, and miscellaneous products. Extruded polystyrene foam is characterized by fully closed cells that provide superior insulative properties and high compressive strength.

Extruded polystyrene foam typically is made by blending a styrenic polymer, a flame retardant compound, and a blowing agent, and extruding the resultant mixture through a die to form the foam. When used as an insulating material, it is important to avoid forming voids or air passages into the cell structures.

For some product applications, it may be desirable to decrease the flammability of such compositions and foams. Flame retardant compounds for use in extruded polystyrene foams have many requirements, including thermal stability, substantial miscibility in polystyrene, and high flame retardancy. The flame retardant compound also must not interfere with the foaming process. For example, if a brominated flame retardant exhibits off-gassing of HBr due to flame retardant degradation, it may be difficult to maintain a consistent closed cell structure. Thus, the flame retardant should exhibit low thermal HBr emission under extrusion and foaming conditions. Furthermore, significant off-gassing of HBr due to flame retardant degradation can cause the molecular weight of the polystyrene to be diminished. While not wishing to be bound by theory, it is believed that the HBr forms bromine radicals that cause scission of the polystyrene chains.

Halogenated flame retardant compounds have been proposed for use in various polymers. See, for example, U.S. Pat. Nos. 3,784,509; 3,868,388; 3,903,109; 3,915,930; and 3,953,397, each of which is incorporated by reference in its entirety. Such compounds are typically aliphatic, cycloaliphatic, or aromatic. Aliphatic halogenated compounds are known to be more effective because they break down more readily. At the same time, such compounds are less temperature resistant than aromatic halogenated flame retardants. Thus, use of aliphatic halogenated flame retardants often is limited to situations in which the processing temperature is very low. See Mack, A. G., Kirk Othmer Chemical Encyclopedia, Flame Retardants, Halogenated Section 4, Online Posting Date: Sep. 17, 2004. However, whether a compound is suitable for a given application depends on the polymer and the method of incorporation. See Troitzsch, J. H., Overview of Flame Retardants: Fire and Fire Safety, Markets and Applications, Mode of Action and Main Families, Role in Fire Gases and Residues, Chimica Ogi/Chemistry Today, Vol. 16, January/February 1998.

Despite the limitations associated with aliphatic and cycloaliphatic brominated compounds, it may be desirable to use such compounds. Unlike many aromatic brominated compounds that are too robust to degrade at the desired temperature, aliphatic and cycloaliphatic brominated compounds are efficacious at the desired temperature. Additionally, polymer foams typically cannot withstand the high loading required to achieve the desired effect.

Thus, there is a need for a flame retardant compound containing aliphatic and/or cycloaliphatic bromine that is suitable for use in extruded polystyrene foam that achieves the desired efficacy at high processing temperatures without adversely affecting the polystyrene or the resulting foam.

### SUMMARY OF THE INVENTION

The present invention is directed generally to a flame-retarded extruded polystyrene foam. According to one aspect of the invention, a polystyrene foam contains a flame retardant compound having the structure: 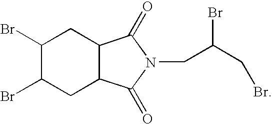
In one aspect of the invention, the flame retardant compound is present in an amount of from about 0.1 to about 10 wt % of the foam. In another aspect, the flame retardant compound is present in an amount of from about 0.5 to about 7 wt % of the foam. In yet another aspect, the flame retardant compound is present in an amount of from about 1 to about 5 wt % of the foam. In still another aspect, the flame retardant compound is present in an amount of from about 3 to about 4 wt % of the foam.

The foam may be formed from a composition having an initial shear viscosity that decreases less than about 15% after about 32 minutes at 190° C. In one aspect, the foam may be formed from a composition having an initial shear viscosity that decreases less than about 10% after about 32 minutes at 175° C.

The foam may be formed from a composition in which the polystyrene has a molecular weight (M_{w}) of at least about 90% of the polystyrene in an identical composition without the flame retardant compound. In another aspect, the foam may be formed from a composition in which the polystyrene has a molecular weight (M_{w}) of at least about 95% of the polystyrene in an identical composition without the flame retardant compound.

The foam may have a ΔE of from about 1 to about 3 compared with an identical polystyrene foam not containing the flame retardant compound. In another aspect the foam may have a ΔE of about 1 compared with an identical polystyrene foam not containing the flame retardant compound.

The extruded polystyrene foam may be used to form an article of manufacture. For example, the extruded polystyrene foam may be used to form thermal insulation.

According to another aspect of the invention, a flame-retarded extruded polystyrene foam contains a flame retardant compound, where the foam has at least one of the following characteristics:

(a) the foam is formed from a composition having an initial shear viscosity that decreases less than about 15% after about 32 minutes at 190° C.;

(b) the foam is formed from a composition having an initial shear viscosity that decreases less than about 10% after about 32 minutes at 175° C.;

(c) the foam is formed from a composition in which the polystyrene has a molecular weight (M_{w}) of at least about 90% of the polystyrene in an identical composition without the flame retardant compound; or

(d) the foam has a ΔE of from about 1 to about 3 when compared with an identical polystyrene foam not containing the flame retardant compound.

The flame retardant compound may be an aliphatic brominated compound, a cycloaliphatic compound, or a combination thereof. For example, the flame retardant compound may be:

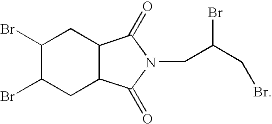

The present invention also contemplates an extruded polystyrene foam containing a flame retardant compound having the structure: 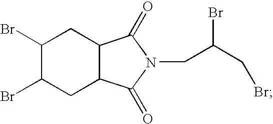
wherein the foam is substantially free of antimony trioxide.

The present invention further contemplates a method of producing flame-retarded extruded polystyrene foam substantially free of antimony trioxide, the method comprising providing a molten polystyrene resin, melting blending with the molten polystyrene from about 0.1 wt % to about 10 wt % of a flame retardant compound having the structure: 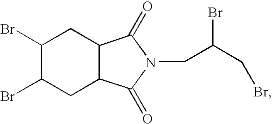
adding a blowing agent to the molten polystyrene to form a flame retardant polystyrene composition, and extruding the flame retardant polystyrene composition through a die.

### DETAILED DESCRIPTION OF THE INVENTION

The present invention is directed generally to extrudable polystyrene foam compositions having flame retardant properties, flame retardant extruded polystyrene foams, methods of making such foams, and products comprising such compositions and foams. According to one aspect of the present invention, a flame retardant extruded polystyrene foam composition comprises polystyrene and at least one flame retardant compound. Optionally, the composition may include one or more synergists, stabilizers, or various other additives.

The flame retardant compounds of the present invention are compounds having the structure: 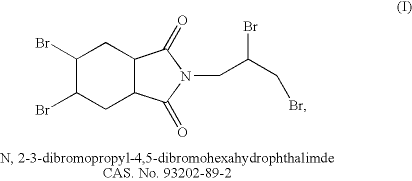
its tautomeric forms, stereoisomers, and polymorphs (collectively referred to as “compound (I)”).

It has been discovered that use of compound (I) to form a flame retardant composition results in a thermally stable and efficacious polystyrene foam. Compound (I) is readily melt blended into the molten polystyrene resin to form a flame retardant composition. Unlike other compounds that tend to degrade during processing and diminish foam quality, compound (I) remains stable during processing and does not adversely affect formation of the polystyrene foam.

According to one aspect of the present invention, the flame retardant composition has an initial shear viscosity that decreases less than about 15% after about 32 minutes at 190° C. In another aspect, the foam may be formed from a composition having an initial shear viscosity that decreases less than about 10% after about 32 minutes at 175° C.

The foam may be formed from a composition in which the polystyrene has a molecular weight (M_{w}) of at least about 90% of the polystyrene in an identical composition without the flame retardant compound. In one aspect, the foam is formed from a composition in which the polystyrene has a molecular weight (M_{w}) of at least about 95% of the polystyrene in an identical composition without the flame retardant compound.

Additionally, the color of the foam is not altered significantly by the presence of the flame retardant compound (I) above. Compared with the polymer without the flame retardant compound, the foam may have a ΔE of from about 0 to about 10. In one aspect, the foam has a ΔE of from about 0 to about 5. In another aspect, the foam has a ΔE of from about 0 to about 3. In another aspect, the foam has a ΔE of from about 1 to about 3. In another aspect the foam has a ΔE of about 1 compared with an identical polystyrene foam not containing the flame retardant compound.

The flame retardant compound is typically present in the composition in an amount of from about 0.1 to about 10 weight (wt) % of the composition. In one aspect, the flame retardant compound is present in an amount of from about 0.3 to about 8 wt % of the composition. In another aspect, the flame retardant compound is present in an amount of from about 0.5 to about 7 wt % of the polymeric. In yet another aspect, the flame retardant compound is present in an amount of from about 1 to about 5 wt % of the composition. In still another aspect, the flame retardant compound is present in an amount of from about 3 to about 4 wt % of the composition. While various exemplary ranges are provided herein, it should be understood that the exact amount of the flame retardant compound used depends on the degree of flame retardancy desired, the specific polymer used, and the end use of the resulting product.

The extruded foam of the present invention is formed from a styrenic polymer. Styrenic polymers that may be used in accordance with the present invention include homopolymers and copolymers of vinyl aromatic monomers, that is, monomers having an unsaturated moiety and an aromatic moiety.

According to one aspect of the present invention, the vinyl aromatic monomer has the formula:
H₂C═CR—Ar;
wherein R is hydrogen or an allyl group having from 1 to 4 carbon atoms and Ar is an aromatic group (including various allyl and halo-ring-substituted aromatic units) having from about 6 to about 10 carbon atoms. Examples of such vinyl aromatic monomers include, but are not limited to, styrene, alpha-methylstyrene, ortho-methylstyrene, meta-methylstyrene, para-methylstyrene, para-ethylstyrene, isopropenyltoluene, isopropenylnaphthalene, vinyl toluene, vinyl naphthalene, vinyl biphenyl, vinyl anthracene, the dimethylstyrenes, t-butylstyrene, the several chlorostyrenes (such as the mono- and dichloro-variants), and the several bromostyrenes (such as the mono-, dibromo- and tribromo-variants).

According to one aspect of the present invention, the monomer is styrene. Polystyrene is prepared readily by bulk or mass, solution, suspension, or emulsion polymerization techniques known in the art. Polymerization can be effected in the presence of free radical, cationic or anionic initiators, such as di-t-butyl peroxide, azo-bis(isobutyronitrile), di-benzoyl peroxide, t-butyl perbenzoate, dicumyl peroxide, potassium persulfate, aluminum trichloride, boron trifluoride, etherate complexes, titanium tetrachloride, n-butyllithium, t-butyllithium, cumylpotassium, 1,3-trilithiocyclohexane, and the like. Additional details of the polymerization of styrene, alone or in the presence of one or more monomers copolymerizable with styrene, are well known and are not described in detail herein.

The polystyrene typically has a molecular weight of at least about 1,000. According to one aspect of the present invention, the polystyrene has a molecular weight of at least about 50,000. According to another aspect of the present invention, the polystyrene has a molecular weight of from about 150,000 to about 500,000. However, it should be understood that polystyrene having a greater molecular weight may be used where suitable or desired.

The flame retardant composition of the present invention optionally may include a synergist. The synergist generally may be present in an amount of from about 0.01 to about 5 wt % of the composition. In one aspect, the synergist is present in an amount of from about 0.05 to about 3 wt % of the composition. In another aspect, the synergist is present in an amount of from about 0.1 to about 1 wt % of the composition. In yet another aspect, the synergist is present in an amount of from about 0.1 to about 0.5 wt % of the composition. In still another aspect, the synergist is present in an amount of about 0.4 wt % of the composition.

The ratio of the total amount of synergist to the total amount of flame retardant compound may be from about 1:1 to about 1:7. According to one aspect of the present invention, the ratio of the total amount of synergist to the total amount of flame retardant compound is from about 1:2 to about 1:4. Examples of synergists that may be suitable for use with the present invention include, but are not limited to, dicumyl peroxide, ferric oxide, zinc oxide, zinc borate, and oxides of a Group V element, for example, bismuth, arsenic, phosphorus, and antimony. According to one aspect of the present invention, the synergist is dicumyl.

However, while the use of a synergist is described herein, it should be understood that no synergist is required to achieve an efficacious flame retardant composition. Thus, according to one aspect of the present invention, the flame retardant composition is substantially free of a synergist. According to yet another aspect of the present invention, the flame retardant composition is substantially free of antimony compounds. According to another aspect of the present invention, the composition includes a synergist, but is substantially free of antimony trioxide.

The flame retardant foam of the present invention optionally includes a thermal stabilizer. Examples of stabilizers include, but are not limited to zeolites; hydrotalcite; talc; organotin stabilizers, for example, butyl tin, octyl tin, and methyl tin mercaptides, butyl tin carboxylate, octyl tin maleate, dibutyl tin maleate; epoxy derivatives; polymeric acrylic binders; metal oxides, for example, ZnO, CaO, and MgO; mixed metal stabilizers, for example, zinc, calcium/zinc, magnesium/zinc, barium/zinc, and barium/calcium/zinc stabilizers; metal carboxylates, for example, zinc, calcium, barium stearates or other long chain carboxylates; metal phosphates, for example, sodium, calcium, magnesium, or zinc; or any combination thereof.

The thermal stabilizer generally may be present in an amount of from about 0.01 to about 10 wt % of the flame retardant compound. In one aspect, the thermal stabilizer is present in an amount of from about 0.3 to about 10 wt % of the flame retardant compound. In another aspect, the thermal stabilizer is present in an amount of from about 0.5 to about 5 wt % of the flame retardant compound. In yet another aspect, the thermal stabilizer is present in an amount of from about 1 to about 5 wt % of the flame retardant compound. In still another aspect, the thermal stabilizer is present in an amount of about 2 wt % of the flame retardant compound.

Other additives that may be used in the composition and foam of the present invention include, for example, extrusion aids (e.g., barium stearate or calcium stearate), or dicumyl compounds and derivatives, dyes, pigments, fillers, thermal stabilizers, antioxidants, antistatic agents, reinforcing agents, metal scavengers or deactivators, impact modifiers, processing aids, mold release agents, lubricants, anti-blocking agents, other flame retardants, other thermal stabilizers, antioxidants, UV stabilizers, plasticizers, flow aids, and similar materials. If desired, nucleating agents (e.g., talc, calcium silicate, or indigo) can be included in the polystyrene composition to control cell size.

The flame retardant composition of the present invention may be used to form flame retardant polystyrene foams, for example, extruded polystyrene foams. Flame retardant polystyrene foam can be prepared by any suitable process known in the art. Such foams can be used for numerous purposes including, but not limited to, thermal insulation.

One exemplary procedure involves melting a polystyrene resin in an extruder. The molten resin then is transferred to a mixer, for example, a rotary mixer having a studded rotor encased within a housing with a studded internal surface that intermeshes with the studs on the rotor. The molten resin and a volatile foaming or blowing agent are fed into the inlet end of the mixer and discharged from the outlet end, the flow being in a generally axial direction. From the mixer, the gel is passed through coolers and from the coolers to a die that extrudes a generally rectangular board. Such a procedure is described for example in U.S. Pat. No. 5,011,866, incorporated by reference in its entirety. Other procedures, such as those described in U.S. Pat. Nos. 3,704,083 and 5,011,866, each of which is incorporated by reference herein in its entirety, include use of systems in which the foam is extruded and foamed under sub-atmospheric, atmospheric, and super-atmospheric pressure conditions. Other examples of suitable foaming processes appear, for example, in U.S. Pat. Nos. 2,450,436; 2,669,751; 2,740,157; 2,769,804; 3,072,584; and 3,215,647, each of which is incorporated by reference in its entirety.

Various foaming agents or blowing agents can be used to produce the flame retardant extruded polystyrene foam of the present invention. Examples of suitable materials are provided in U.S. Pat. No. 3,960,792, incorporated by reference herein in its entirety. Volatile carbon-containing chemical substances are used widely for this purpose including, for example, aliphatic hydrocarbons including ethane, ethylene, propane, propylene, butane, butylene, isobutane, pentane, neopentane, isopentane, hexane, heptane, or any mixture thereof; volatile halocarbons and/or halohydrocarbons, such as methyl chloride, chlorofluoromethane, bromochlorodifluoromethane, 1,1,1-trifluoroethane, 1,1,1,2-tetrafluoroethane, dichlorofluoromethane, dichlorodifluoromethane, chlorotrifluoromethane, trichlorofluoromethane, sym-tetrachlorodifluoroethane, 1,2,2-trichloro-1,1,2-trifluoroethane, sym-dichlorotetrafluoroethane; volatile tetraalkylsilanes, such as tetramethylsilane, ethyltrimethylsilane, isopropyltrimethylsilane, and n-propyltrimethylsilane, and any mixture thereof. One example of a fluorine-containing blowing agent is 1,1-difluoroethane, provided under the trade name HFC-152a (FORMACEL Z-2, E.I. duPont de Nemours and Co.). Water-containing vegetable matter such as finely-divided corn cob can also be used as a blowing agent. As described in U.S. Pat. No. 4,559,367, incorporated by reference herein in its entirety, such vegetable matter can also serve as a filler. Carbon dioxide also may be used as a blowing agent, or as a component thereof. Methods of using carbon dioxide as a blowing agent are described, for example, in U.S. Pat. Nos. 5,006,566; 5,189,071; 5,189,072; and 5,380,767, each of which is incorporated by reference herein in its entirety. Other examples of blowing agents and blowing agent mixtures include nitrogen, argon, or water with or without carbon dioxide. If desired, such blowing agents or blowing agent mixtures can be mixed with alcohols, hydrocarbons, or ethers of suitable volatility. See, for example, U.S. Pat. No. 6,420,442, incorporated by reference herein in its entirety.

The extruded polystyrene foam typically may include the various components and additives in the relative amounts set forth above in connection with the compositions used to form the foam. Thus, for example, an extruded polystyrene foam of the present invention may contain a flame retardant compound in an amount of from about 0.1 to about 10 wt % of the foam. In one aspect, the flame retardant compound is present in an amount of from about 0.3 to about 8 wt % of the foam. In another aspect, the flame retardant compound is present in an amount of from about 0.5 to about 7 wt % of the foam. In yet another aspect, the flame retardant compound is present in an amount of from about 1 to about 5 wt % of the foam. In still another aspect, the flame retardant compound is present in an amount of about from about 3 to about 4 wt % of the foam. While certain ranges and amounts are described herein, it should be understood that other relative amounts of the components in the foam are contemplated by the present invention.

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may be suggested to one of ordinary skill in the art without departing from the spirit of the present invention or the scope of the appended claims.

### EXAMPLE 1

N, 2-3-dibromopropyl-4,5-dibromohexahydrophthalimde (“compound (I)”) was prepared according to the following exemplary procedure. Other procedures are known in the art and are not discussed herein.

A 4-neck 5 L jacketed flask fitted with nitrogen flow and a water-cooled reflux condenser was charged with 900 g xylenes and 1 kg (6.57 mol) of tetrahydrophthalic anhydride (THPA, 95-96%). To the stirred (250 rpm) slurry, allylamine (413 g, 7.23 mol) was added over 45 min via an addition funnel. The reaction was exothermic and the temperature was maintained at 50 to 80° C. by use of a circulating bath fluid set to 30° C. After the allylamine addition was complete, the bath temperature was increased to 165° C., and held for 2 hours (reaction complete by GC). The circulating bath fluid temperature was reduced to 150° C., and solvent was removed using a vacuum aspirator (˜3″ Hg; Rxn T=138-140° C.). After removal of most of the xylenes, the bath temperature was reduced to 65° C. (Rxn T=56° C.), and 500 g of BCM (bromochloromethane) was added prior to washing with a base wash. A water solution (1,260 g water, 50 g Na₂CO₃) was added and stirred followed by phase separation. The dark red/brown organic phase (1,907 g: ˜500 g BCM, ˜1,256 g product (65.8 wt %), ˜200 g xylenes) was separated from the orange aqueous phase (1,332 g). GC analysis showed ˜100 area % product after caustic workup.

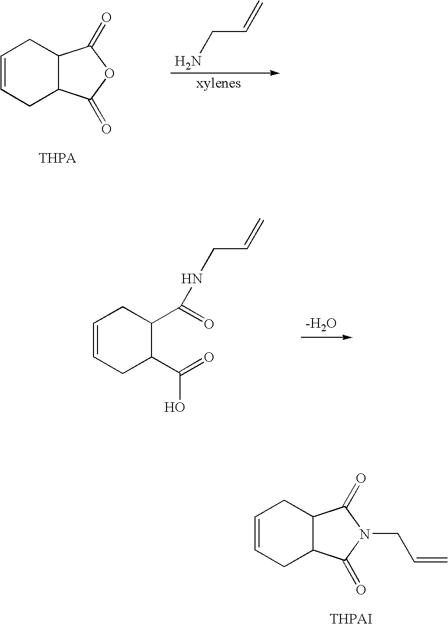

N-allyl-tetrahydrophthalimide:

| Reagent | FW | Mass, g | Mol | eq |
|---|---|---|---|---|
| Xylenes | | 900 | | |
| THPA | 152.15 | 1,000 | 6.57 | 1 |
| Allylamine | 57.10 | 413 | 7.23 | 1.1 |
| BCM | | 500 | | |
| THPAI | 191.23 | 1,200 | | |

A 4-neck 5 L jacketed flask fitted with nitrogen flow was charged with about 500 g BCM, about 20 g aqueous HBr, about 20 g ethanol, and the circulating bath temperature was cooled to about 2 to 3° C. (reaction T=5° C. initially). To the stirred (300 rpm) solvents were co-fed, above surface, from opposite ends of the flask via addition funnels, for about 2.5 hours, a solution of about 2,209 g (13.8 mol, 2.1-2.2 eq) of bromine, and the BCM/xylenes solution of THPAI (1,907 g). The reaction temperature remained below 33° C. The solution was stirred for another 30 min, and an aqueous solution of water (1450 g), Na₂SO₃ (20 g, 0.16 mol, FW=126), Na₂CO₃ (90 g, 0.85 mol, FW=106) were added to wash the organic phase (aqueous phase pH=8-9). Methanol (1.7 kg) was added to the reactor at 45° C., and the reaction temperature was increased to about 50° C. (bath T about 68° C.). Another 1 kg of methanol was added as the reactor cooled to room temperature. The powder was filtered, rinsed with methanol, and dried at about 65° C. in an air circulating oven for about 2.5 hours to yield 2,625 g of white powder product (76% yield) Mp 104-118° C.

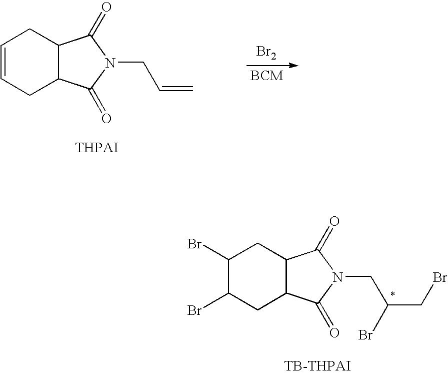

Brominated N-allyl-tetrahydrophthalimide (62.6 wt % Br):

| Reagent | FW | Mass, g | Mol | eq |
|---|---|---|---|---|
| xylenes | | ˜200 | | |
| BCM | | 1,000 | | |
| EtOH | | 20 | | |
| HBr (aq) | | 20 | | |
| THPAI soln | 191.23 | ˜1250 | 6.54 | 1.0 |
| Br₂ | 159.82 | 2209 | 13.8 | 2.1-2.2 |
| MeOH | | 2,700 | | |
| TB-THPAI | 510.85 | 2,625 | | |

### EXAMPLE 2

To illustrate flame retardant efficacy, various compositions containing N, 2-3-dibromopropyl-4,5-dibromohexahydrophthalimde (“compound (I)”) were prepared and subjected to ASTM Standard Test Method D 2863-87, commonly referred to as the limiting oxygen index (LOI) test. In this test, the higher the LOI value, the more flame resistant the composition.

Sample A was prepared by making a concentrate (10 wt % compound I), and then letting the concentrate down into a neat resin at a ratio of about 35 wt % concentrate to about 65 wt % PS-168 neat resin and extruding low density foam via carbon dioxide injection. PS-168 is a general purpose non-flame retarded grade of unreinforced crystal polystyrene commercially available from Dow Chemical Company. It has a weight average molecular weight of about 172,000 daltons and a number average molecular weight of about 110,000 daltons (measured by GPC). The molecular weight analyses were determined in THF with a modular Waters HPLC system equipped with a Waters 410 differential refractometer and a Precision Detectors model PD-2000 light scattering intensity detector. The columns used to perform the separation were 2 PL Gel Mixed Bed B columns (from Polymer Labs). Polystyrene standards, also from Polymer Labs, were used as calibration standards in the determination of molecular weight values.

The concentrate contained about 10 wt % compound (I), about 0.5 wt % hydrotalcite thermal stabilizer, about 4.3 wt % Mistron Vapor Talc, about 1.5 wt % calcium stearate, and about 83.7 wt % Dow PS-168. The concentrates were produced on a Werner & Phleiderer ZSK-30 co-rotating twin screw extruder at a melt temperature of about 175° C. A standard dispersive mixing screw profile was used at about 250 rpm and a feed rate of about 8 kg/hour. PS-168 resin was fed via a single screw gravimetric feeder, and the powder additives were pre-mixed and fed using a twin screw powder feeder.

The concentrate was then mixed into neat Dow polystyrene PS-168 using the same twin screw extruder at a ratio of about 35 wt % concentrate to about 65 wt % polystyrene to produce foam using the following conditions: temperatures of Zones 1 (about 175° C.), 2 (about 160° C.), 3 (about 130° C.), and 4 (about 130° C.), about 145° C. die temperature, about 60 rpm screw speed, about 3.2 kg/hour feed rate, 40/80/150 screen pack, from about 290 to about 310 psig carbon dioxide pressure, about 160° C. melt temperature, from about 63 to about 70% torque, and from about 2 to about 3 ft/minute takeoff speed.

The foam contained about 3.5 wt % flame retardant (about 2.2 wt % bromine), and about 1.5 wt % talc as a nucleating agent for the foaming process. DHT4A hydrotalcite in an amount of about 5 wt % of the flame retardant compound was also used to stabilize the flame retardant during the extrusion and foam-forming process. A standard two-hole stranding die (⅛ inch diameter holes) was used to produce the foams, with one hole plugged. The resulting ⅝ inch diameter foam rods had a very thin surface skin (0.005 inches or less) and a fine closed cell structure. Carbon dioxide gas was injected into barrel #8 (the ZSK-30 is a 9-barrel extruder). The rods were foamed with carbon dioxide to a density of about 9.0 lbs/ft³ (0.14 specific gravity).

Control sample K was prepared as in Sample A, except that the concentrate contained about 9 wt % SAYTEX® EP900SG stabilized hexabromocyclododecane (HBCD).

The results of the evaluation are presented in Table 1.

TABLE 1

| Sample | Description | LOI % O₂ |
|---|---|---|
| A-foam | PS-168 with compound I | 25.8 |
| K-foam | PS-168 with HP-900SG | 26.1 |

The results indicate that the N, 2-3-dibromopropyl-4,5-dibromohexahydrophthalimde is a highly efficacious flame retardant, comparable to commercially available HBCD.

### EXAMPLE 3

The thermal stability of N, 2-3-dibromopropyl-4,5-dibromohexahydrophthalimde (“compound (I)”) used in accordance with the present invention was evaluated using the Thermal HBr Measurement Test.

First, a sample of from about 0.5 to about 1.0 g flame retardant was weighed into a three neck 50 mL round bottom flask. Teflon tubing was then attached to one of the openings in the flask. Nitrogen was fed into the flask through the Teflon tubing at a flow rate of about 0.5 SCFH. A small reflux condenser was attached to another opening on the flask. The third opening was plugged. An about 50 vol % solution of glycol in water at a temperature of about 85° C. was run through the reflux condenser. Viton tubing was attached to the top of the condenser and to a gas scrubbing bottle. Two more bottles were attached in series to the first. All three bottles had about 90 mL of about 0.1 N NaOH solution. After assembling the apparatus, the nitrogen was allowed to purge through the system for about 2 minutes. The round bottom flask was then placed into an oil bath at about 220° C. and the sample was heated for about 15 minutes. The flask was then removed from the oil bath and the nitrogen was allowed to purge for about 2 minutes. The contents of the three gas scrubbing bottles were transferred to a 600 mL beaker. The bottles and viton tubing were rinsed into the beaker. The contents were then acidified with about 1:1 HNO₃ and titrated with about 0.01 N AgNO₃. Samples were run in duplicate and an average of the two measurements was reported. Lower thermal HBr values are preferred for a thermally stable flame retardant in extrudable polystyrene foams or extruded polystyrene foams.

SAYTEX® HP-900 was also evaluated as described above. SAYTEX® HP-900 is HBCD, commercially available from Albemarle Corporation.

The results of the evaluation are presented in Table 2.

TABLE 2

| Description | HBr (ppm) |
|---|---|
| Compound (I) | 2,058 |
| HP-900 HBCD | 50,000 |

The results of this evaluation indicate that the flame retardant described herein is thermally stable, not decomposing to release excessive amounts of thermally cleaved HBr upon heating at typical operating temperatures for use in extruded polystyrene foams.

### EXAMPLE 4

The melt stability of N, 2-3-dibromopropyl-4,5-dibromohexahydrophthalimde (“compound (I)”) in polystyrene was also evaluated. Samples were prepared and subjected to ASTM Standard Test Method D 3835-90, commonly referred to as the Melt Stability Test.

Various samples containing about 10 weight % concentrate of compound (I) in polystyrene were heated in a barrel and extruded over time. A Dynisco-Kayeness Polymer Test Systems LCR 6052 Rheometer (Model D6052M-115, serial no. 9708-454)/WinKARS instrument/software package was used to measure the viscosity as a function of time in the heated barrel. Evaluations were conducted at a shear rate of 500 sec⁻¹ using a 20/1 L/d tungsten carbide die and a 9.55 mm barrel diameter, for dwell times of about 6.5, 13, 9.5, 25.9, and 32.4 minutes. For thermally stable materials, the viscosity should not substantially change over time.

Samples A and K are described above in Example 2. Control sample PS-168 is PS-168 polystyrene resin (without a flame retardant compound).

Comparative sample L was prepared by making a PS-168 resin concentrate containing about 13 wt % compound (II), about 0.5 wt % hydrotalcite thermal stabilizer, about 4.3 wt % Mistron Vapor Talc, about 1.5 wt % calcium stearate, and about 80.7 wt % Dow PS-168.

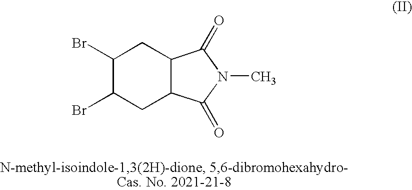

The concentrate was produced on a Werner & Phleiderer ZSK-30 co-rotating twin-screw extruder at a melt temperature of about 175° C. A standard dispersive mixing screw profile was used at about 250 rpm and a feed rate of about 8 kg/hour. PS-168 resin concentrate and powder additives were pre-mixed and fed via a single screw gravimetric feeder. The concentrate ran poorly, turning dark orange over time. Off-gassing occurred, with loss of resin melt strength. Stranding became impossible after about 10 minutes of extrusion.

Comparative sample M was prepared by making a PS-168 resin concentrate containing about 12.5 wt % compound (III), about 0.5 wt % hydrotalcite thermal stabilizer, about 4.3 wt % Mistron Vapor Talc, about 1.5 wt % calcium stearate, and about 81.2 wt % Dow PS-168.

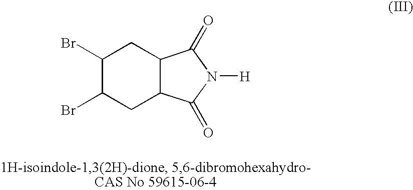

The concentrate was produced on a Werner & Phleiderer ZSK-30 co-rotating twin screw extruder at a melt temperature of about 175° C. A standard dispersive mixing screw profile was used at about 250 rpm and a feed rate of about 8 kg/hour. PS-168 resin concentrates and powder additives were pre-mixed and fed via a single screw gravimetric feeder. The concentrate ran reasonably well in terms of maintaining melt strength and good stranding, but the material turned dark red-orange from the outset. Initial off-gassing stabilized after about 5-10 minutes.

The results of the evaluation are presented in Tables 3 and 4.

TABLE 3
Shear Viscosity (Pa-sec) at 175° C.

| | | 6.5 | 13 | 19.5 | 25.9 | 32.4 |
|---|---|---|---|---|---|---|
| Sample | Description | min | min | min | min | min |
| A-conc | Compound I in | 283 | 279 | 279 | 270 | 279 |
| | polystyrene | | | | | |
| K-conc | HP-900SG in | 488 | 478 | 464 | 465 | 480 |
| | polystyrene | | | | | |
| PS-168 | Polystyrene | 616 | 587 | 587 | 617 | 612 |
| | resin | | | | | |
| L-conc | Compound II in | 192 | 190 | 181 | 165 | 161 |
| | polystyrene | | | | | |
| M-conc | Compound III in | 356 | 335 | 336 | 343 | 354 |
| | polystyrene | | | | | |

TABLE 4
Shear Viscosity (Pa-sec) at 190° C.

| | | 6.5 | 13 | 19.5 | 25.9 | 32.4 |
|---|---|---|---|---|---|---|
| Sample | Description | min | min | min | min | min |
| A-conc | Compound I in | 196 | 195 | 185 | 177 | 170 |
| | polystyrene | | | | | |
| K-conc | HP-900SG in | 271 | 265 | 265 | 268 | 266 |
| | polystyrene | | | | | |
| PS-168 | Polystyrene | 362 | 355 | 355 | 355 | 359 |
| | resin | | | | | |

The shear viscosity of Sample A-conc remained stable (within 5% of its initial value) at 175° C. Sample A-conc begins to show some minor instability at 190° C., showing a decrease of about 13% in the shear viscosity.

The shear viscosity of Sample L-conc began to show instability by the end of the evaluation at 175° C., as the shear viscosity dropped beyond 15% of its initial value. The shear viscosity of Sample M-conc was stable in its flow properties during the full 32-minute dwell time of the test, with its shear viscosities remaining stable throughout the measurement (within 5% of its initial value). The shear viscosity of Samples L-conc and M-conc at 190° C. was not measured.

### EXAMPLE 5

The impact of extrusion on the molecular weight of various flame retardant concentrates and foams was determined by evaluating the samples using GPC before and after extrusion.

Samples A and K are described in Example 2. Samples L, M, N, and PS-168 are described in Example 4. Sample N was prepared as in Example 2 except that 30 wt % compound (IV) was used instead of compound (I).

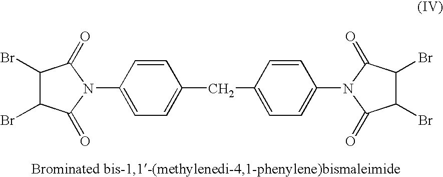

The concentrate contained about 30 wt % (1.11 kg) compound (IV) and about 70 weight % (2.59 kg) PS-168. The concentrate was produced on a Leistritz/Haake Micro 18 counter-rotating twin screw extruder at a melt temperature of about 170° C. A standard dispersive mixing screw profile was used at about 100 rpm and a feed rate of about 3 kg/hour. The polystyrene resin concentrate and the powder additives were pre-mixed and fed using a single-screw gravimetric feeder. The extruded strands exhibited slight foaming and odor, indicative of thermal release of HBr.

TABLE 5

| | | | MW, after | |
|---|---|---|---|---|
| | | MW, initial | extrusion | |
| Sample | Description | (Daltons) | (Daltons) | Difference |
| A-conc | Polystyrene/ | 172,000 | 164,000 | −5% |
| | Compound I | | | |
| K-conc | Polystyrene/ | 166,000 | 161,400 | −2.8% |
| | HP-900SG | | | |
| L-conc | Polystyrene/ | 177,400 | 154,338 | −13% |
| | compound II | | | |
| M-conc | Polystyrene/ | 176,700 | 162,564 | −8% |
| | compound III | | | |
| N-conc | Polystyrene/ | 240,000 | 120,000 | −50% |
| | compound IV | | | |
| PS-168 | Polystyrene | 172,000 | 172,000 | 0 |

The results indicate that compound (I) is highly stable and causes minimal, if any, degradation of the polystyrene. In contrast, compound (II) and compound (IV) cause significant degradation of the polystyrene and are, therefore, not suitable for producing a flame retardant extruded polystyrene foam.

### EXAMPLE 6

A Hunter Lab Color QUEST Spectrocolorimeter (diffuse geometry) was used to measure the Delta E (ΔE) value for various flame retardant concentrates according to ASTM D6290-98 “Standard Test Method for Color Determination of Plastic Pellets”.

Samples A, K, L, M, N and PS-168 are described above. The results are presented in Table 6.

TABLE 6

| Type | Description | Sample | ΔE | Color |
|---|---|---|---|---|
| Concentrate | Compound I/PS | A-conc | 10 | Slight yellow |
| | HP-900SG/PS | K-conc | 8 | Slight yellow |
| | Compound II/PS | L-conc | 18 | Brown-orange |
| | Compound III/PS | M-conc | 35 | Dark red-orange |
| | Polystyrene | PS-168 | 0 | Translucent |
| | resin | | | white |
| Foam | Compound I/PS | A-foam | 1 | White |
| | HP-900SG/PS | K-foam | 1 | White |
| | Compound II/PS | L-foam | 37 | Orange |
| | Compound III/PS | M-foam | 40 | Dark orange |
| | Polystyrene | PS-168 | 0 | Translucent |
| | foam | | | white |

The results indicated that compound (I) is highly suitable for use in forming a polystyrene foam. The lack of color change is demonstrative of high thermal stability with little or no polymer degradation. Samples L-foam and M-foam have significant coloration that render the flame retardant compounds (II) and (III) unsuitable for forming extruded polystyrene foams.

The foregoing description has been presented for purposes of illustration and description. It is not intended to be exhaustive or to limit the invention to the precise examples or embodiments disclosed. Obvious modifications or variations are possible in light of the above teachings. The embodiment or embodiments discussed were chosen and described to provide the best illustration of the principles of the invention and its practical application to enable one of ordinary skill in the art to utilize the invention in various aspects and with various modifications as are suited to the particular use contemplated. All such modifications and variations are within the scope of the invention as determined by the appended claims when interpreted in accordance with the breadth to which they are fairly and legally entitled.

Even though the claims hereinafter may refer to substances, components, and/or ingredients in the present tense (“comprises”, “is”, etc.), the reference is to the substance, component, or ingredient as it existed at the time just before it was first contacted, blended, or mixed with one or more other substances, components and/or ingredients, or if formed in solution, as it would exist if not formed in solution, all in accordance with the present disclosure. It does not matter that a substance, component, or ingredient may have lost its original identity through a chemical reaction or transformation during the course of such contacting, blending, mixing, or in situ formation, if conducted in accordance with this disclosure.

What is claimed is:

1. A flame-retarded extruded polystyrene foam containing a flame retardant compound having the structure:

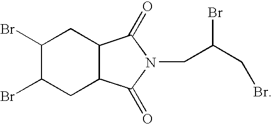

2. The extruded polystyrene foam of claim 1, wherein the flame retardant compound is present in an amount of from about 0.1 to about 10 wt % of the foam.

3. The extruded polystyrene foam of claim 1, wherein the flame retardant compound is present in an amount of from about 0.5 to about 7 wt % of the foam.

4. The extruded polystyrene foam of claim 1, wherein the flame retardant compound is present in an amount of from about 1 to about 5 wt % of the foam.

5. The extruded polystyrene foam of claim 1, wherein the flame retardant compound is present in an amount of from about 3 to about 4 wt % of the foam.

6. The extruded polystyrene foam of claim 1, formed from a composition having an initial shear viscosity that decreases less than about 15% after about 32 minutes at 190° C.

7. The extruded polystyrene foam of claim 1, formed from a composition having an initial shear viscosity that decreases less than about 10% after about 32 minutes at 175° C.

8. The extruded polystyrene foam of claim 1, formed from a composition in which the polystyrene has a molecular weight (M_{w}) of at least about 90% of the polystyrene in an identical composition without the flame retardant compound.

9. The extruded polystyrene foam of claim 1, formed from a composition in which the polystyrene has a molecular weight (M_{w}) of at least about 95% of the polystyrene in an identical composition without the flame retardant compound.

10. The extruded polystyrene foam of claim 1, having a ΔE of from about 1 to about 3 compared with an identical polystyrene foam not containing the flame retardant compound.

11. The extruded polystyrene foam of claim 1, having a ΔE of about 1 compared with an identical polystyrene foam not containing the flame retardant compound.

12. The extruded polystyrene foam of claim 1, provided as an article of manufacture.

13. The extruded polystyrene foam of claim 12, wherein the article of manufacture is thermal insulation.

14. A flame-retarded extruded polystyrene foam containing a flame retardant compound, the foam having at least one of the following characteristics:
(a) the foam is formed from a composition having an initial shear viscosity that decreases less than about 15% after about 32 minutes at 190° C.;
(b) the foam is formed from a composition having an initial shear viscosity that decreases less than about 10% after about 32 minutes at 175° C.;
(c) the foam is formed from a composition in which the polystyrene has a molecular weight (M_{w}) of at least about 90% of the polystyrene in an identical composition without the flame retardant compound; or
(d) the foam has a ΔE of from about 1 to about 3 compared with an identical polystyrene foam not containing the flame retardant compound.

15. The extruded polystyrene foam of claim 14, wherein the flame retardant compound is an aliphatic brominated compound, a cycloaliphatic compound, or a combination thereof.

16. The extruded polystyrene foam of claim 14, wherein the flame retardant compound is:

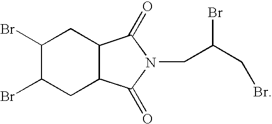

17. An extruded polystyrene foam containing a flame retardant compound having the structure: 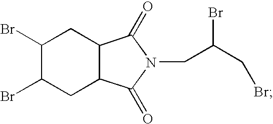
wherein the foam is substantially free of antimony trioxide.

18. A method of producing flame-retarded extruded polystyrene foam substantially free of antimony trioxide, the method comprising:
providing a molten polystyrene resin;
melting blending with the molten polystyrene from about 0.1 wt % to about 10 wt % of a flame retardant compound having the structure: 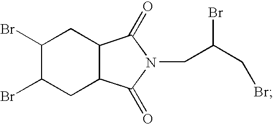
adding a blowing agent to the molten polystyrene to form a flame retardant polystyrene composition; and
extruding the flame retardant polystyrene composition through a die.
